(19) United States
(12) Patent Application Publication
(10) Pub. No.: US 2015/0108842 A1
(43) Pub. Date: Apr. 23, 2015

(54) SYSTEMS AND METHODS FOR REDUCING CROSS-SUPPLY CURRENT

(71) Applicant: QUALCOMM Incorporated, San Diego, CA (US)

(72) Inventors: Nan Chen, San Diego, CA (US); Narasimhan Vasudevan, San Diego, CA (US); Michael Thomas Fertsch, San Diego, CA (US)

(73) Assignee: QUALCOMM Incorporated, San Diego, CA (US)

(21) Appl. No.: 14/056,851

(22) Filed: Oct. 17, 2013

(51) Int. Cl. H02J 1/00

(52) U.S. Cl. CPC H02J 1/00
USPC 307/52

(57) ABSTRACT

Techniques for reducing cross-supply current are described herein. In one embodiment, a power circuit comprises a bypass switch coupled between a first power supply and an internal power supply, and a voltage regulator coupled between a second power supply and the internal power supply. The power circuit also comprises a shut-off circuit configured to detect the first power supply powering up before the second power supply during a power-up sequence, to shut off the bypass switch upon detecting the first power supply powering up before the second power supply, to detect the second power supply powering up during the power-up sequence, and to release control of the bypass switch to a controller upon detecting the second power supply powering up.

### BACKGROUND

1. Field

Aspects of the present disclosure relate generally to power management, and more particularly, to reducing cross-supply current.

2. Background

A power management integrated circuit (PMIC) may be used to convert power from a battery, a wall adapter, or another power source into a plurality of power-supply voltages for powering various components of a chip. During power-up, the PMIC may sequentially power up two or more power supplies according to a power-up sequence. As a result, one of the power supplies is powered up before another one of the power supplies. This may cause cross-supply current to temporarily flow between the power supplies, which can upset logic coupled to one or more of the power supplies.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to an aspect, a power circuit is described herein. The power circuit comprises a bypass switch coupled between a first power supply and an internal power supply, and a voltage regulator coupled between a second power supply and the internal power supply. The power circuit also comprises a shut-off circuit configured to detect the first power supply powering up before the second power supply during a power-up sequence, to shut off the bypass switch upon detecting the first power supply powering up before the second power supply, to detect the second power supply powering up during the power-up sequence, and to release control of the bypass switch to a controller upon detecting the second power supply powering up.

A second aspect relates to a method for preventing cross-supply current between a first power supply and a second power supply in a power circuit. The power circuit includes a bypass switch coupled between the first power supply and an internal power supply, and a voltage regulator coupled between the second power supply and the internal power supply. The method comprises detecting the first power supply powering up before the second power supply during a power-up sequence, shutting off the bypass switch upon detecting the first power supply powering up before the second power supply, detecting the second power supply powering up during the power-up sequence, and releasing control of the bypass switch to a controller upon detecting the second power supply powering up.

A third aspect relates to an apparatus for preventing cross-supply current between a first power supply and a second power supply in a power circuit. The power circuit comprises a bypass switch coupled between the first power supply and an internal power supply, and a voltage regulator coupled between the second power supply and the internal power supply. The apparatus comprises means for detecting the first power supply powering up before the second power supply during a power-up sequence, means for shutting off the bypass switch upon detecting the first power supply powering up before the second power supply, means for detecting the second power supply powering up during the power-up sequence, and means for releasing control of the bypass switch to a controller upon detecting the second power supply powering up.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 shows an example of a power circuit for a system on a chip (SoC) coupled to a PMIC.

FIG. 2 is a timing diagram illustrating exemplary power-supply voltages during a power-up sequence.

FIG. 3 shows an example of the power circuit in FIG. 1, in which power supply VDD1 is powered up before power supply VDD3.

FIG. 4 is a timing diagram illustrating a rise in one of the power-supply voltages shown in FIG. 2 caused by current flow through an intrinsic diode of a transistor.

FIG. 5 shows a power circuit for preventing cross-supply current according to an embodiment of the present disclosure.

FIG. 6 shows an exemplary implementation of the power circuit in FIG. 5 according to an embodiment of the present disclosure.

FIG. 7 shows a power circuit for shunting leakage current to ground during power-up according to an embodiment of the present disclosure.

FIG. 8 is a flow diagram of a method for preventing cross-supply current according to an embodiment of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

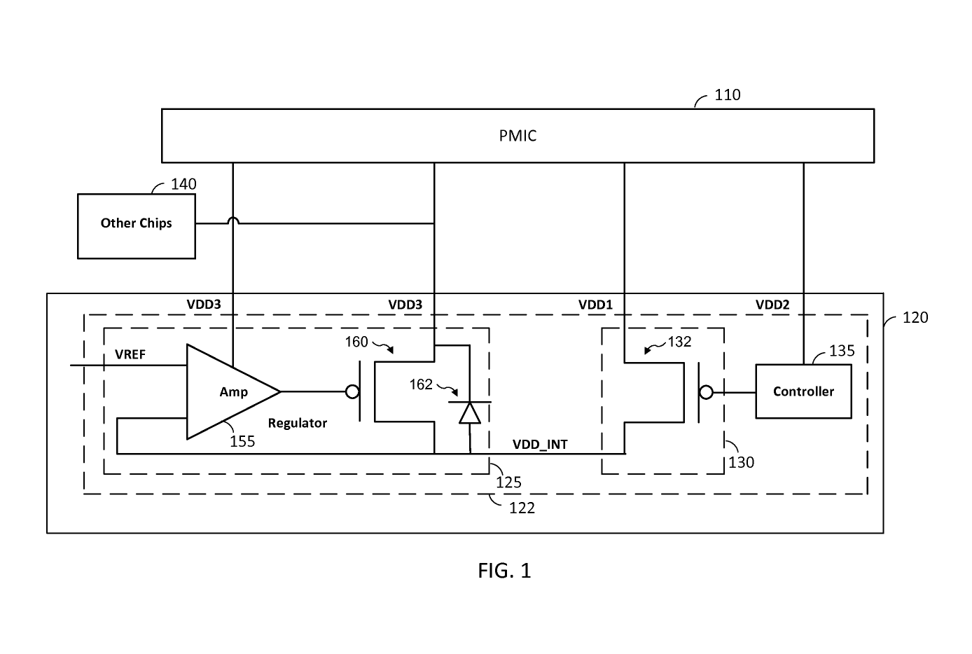

FIG. 1 shows an example of a power management integrated circuit (PMIC) 110 that provides power-supply voltages to power supplies VDD1, VDD2 and VDD3 of a system on a chip (SoC) 120. As used herein, the term “power supply” may refer to a rail or node on which a voltage is provided to power one or more devices. The PMIC 110 may be located on a separate chip and may manage power to the SoC 120 and one or more other chips.

The SoC 120 includes a power circuit 122 coupled to power supplies VDD1, VDD2 and VDD3. The power circuit 122 is configured to provide a voltage at an internal power supply VDD_INT to power one or more circuits (not shown) of the SoC 120. The power circuit 122 comprises a voltage regulator 125, a bypass switch 130 and a controller 135, and can operate in different power modes under the control of the controller 135. The power modes may include a regulated power mode and a non-regulated power mode.

In the regulated power mode, the controller 135 turns on the voltage regulator 125 and turns off the bypass switch 130. In this mode, the voltage regulator 125 provides a regulated voltage at the internal power supply VDD_INT using the voltage at power supply VDD3. The regulated voltage has low noise, and may be used to power noise-sensitive components.

In the non-regulated power mode, the controller 135 turns on the bypass switch 130 and turns off the voltage regulator 125. In this mode, the bypass switch 130 provides a direct path between power supply VDD1 and the internal power supply VDD_INT. The voltage at the internal power supply VDD_INT is nosier in the non-regulated power mode than the regulated power mode. However, the bypass switch 130 is more power efficient than the voltage regulator 125, and therefore may be used to save power when supply noise is less critical.

In one example, the internal power supply VDD_INT may be used to power one or more memory physical (PHY) blocks (not shown) on the SoC 120. The memory PHY blocks may be used to generate data signals, control signals and a data strobe for interfacing a circuit (e.g., memory controller) on the SoC 120 with an external memory device (e.g., DRAM device). The memory PHY blocks may support data rate adaption, in which the memory PHY blocks may be adjusted to operate at different data rates (e.g., depending on a particular application).

In this example, the controller 135 may be configured to operate the power circuit 122 in the regulated mode when the memory PHY blocks operate at higher data rates. This is because the memory PHY blocks may be more sensitive to supply noise when operating at higher speeds. The controller 135 may be configured to operate the power circuit 122 in the non-regulated mode when the memory PHY blocks operate at lower data rates. This is because the memory PHY blocks may be more tolerant of supply noise when operating at lower speeds. Operating the power circuit 122 in the non-regulated mode conserves power since the bypass switch 130 is more power efficient than the voltage regulator 125. It is to be appreciated that embodiments of the present disclosure are not limited to this example, and that embodiments of the present disclosure may be used in any application in which the sensitivity of a circuit to supply noise changes (e.g., for different operating modes of the circuit).

The bypass switch 130 may be implemented using a first p-type field effect transistor (PFET) 132, in which the controller 135 drives the gate of the first PFET 132 to turn the first PFET 132 on and off In this example, the controller 135 drives the gate of the first PFET 132 low to turn on the first PFET 132 and drives the gate of the first PFET 132 high to turn off the first PFET 132. The internal power supply VDD_INT has a voltage approximately equal to VDD1 when the first PFET 132 is turned on.

The voltage regulator 125 may be implemented using a low-dropout (LDO) regulator, as shown in the example in FIG. 1. In this example, the voltage regulator 125 comprises an amplifier 155 and a second PFET 160 coupled between power supply VDD3 and the internal power supply VDD_INT. A first input of the amplifier 155 is coupled to a reference voltage VREF and a second input of the amplifier 155 is coupled to the internal power supply VDD_INT. The output of the amplifier 155 is coupled to the gate of the second PFET 160. Coupling the internal power supply VDD_INT to the second input of the amplifier 155 forms a feedback loop. The feedback loop causes the amplifier 155 to drive the gate of the second PFET 160 in a direction that minimizes the difference between VREF and the voltage at the internal power supply VDD_INT, and thus regulates the voltage at the internal power supply VDD_INT to be approximately equal to VREF. In this example, the amplifier 155 may have an enable input (not shown) coupled to the controller 135, and the controller 135 may turn on the voltage regulator 125 by enabling the amplifier 155 and turn off the voltage regulator 125 by disabling the amplifier 155. When the amplifier 155 is disabled, the output of the amplifier 155 may be pulled high to turn off the second PFET 160. It is to be appreciated that embodiments of the present disclosure are not limited to the particular voltage regulator 125 shown in FIG. 1, and that other types of voltage regulators may also be used.

The second PFET 160 may include an intrinsic p-n junction diode 162 formed by a P+ source/drain region and an N-well in the second PFET 160. During normal operation, power supply VDD3 has a higher voltage than power supply VDD1. As a result, the diode 162 is reversed biased during normal operation, and therefore does not conduct current during normal operation.

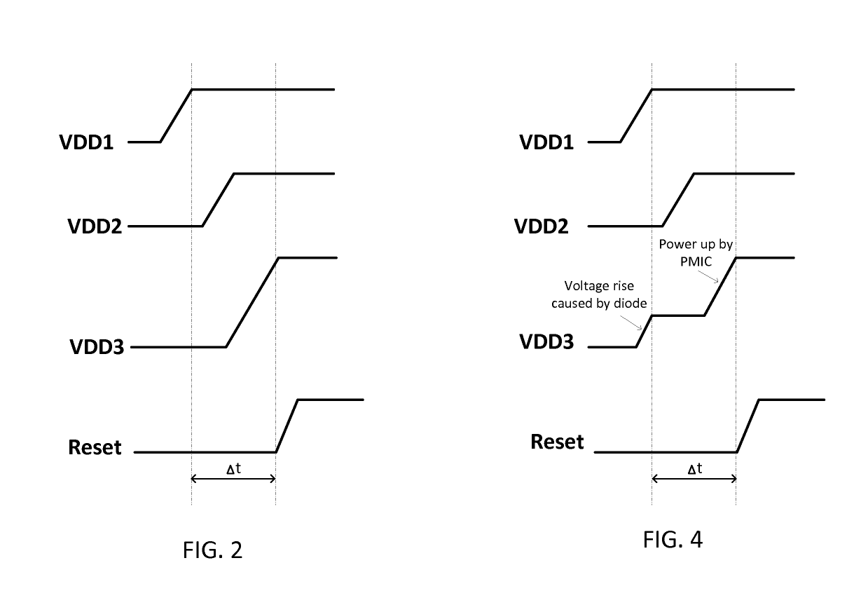

During power-up, the voltages at power supplies VDD1, VDD2 and VDD3 are all initially zero volts. The PMIC 110 may then sequential power up power supplies VDD1, VDD2 and VDD3 to their normal operating voltages in a power-up sequence. An example of a power-up sequence is shown in FIG. 2. In this example, the PMIC 110 first powers up power supply VDD1 to its normal operating voltage (e.g., 1.0V). The PMIC 110 then powers up power supply VDD2 to its normal operating voltage (e.g., 1.0V) after a delay. Lastly, the PMIC 110 powers up power supply VDD3 to its normal operating voltage (e.g., 1.8V) after another delay. Thus, power supply VDD1 is powered up before power supply VDD3. In FIG. 2, the time delay between the time that power supply VDD1 is powered up and the time that power supply VDD3 is powered up is represented by Δt. The controller 135 may not control the voltage regulator 125 or the bypass switch 130 until the controller 135 has been reset, which may occur after VDD3 has been powered up.

By powering up power supply VDD1 before power supply VDD3, the power-up sequence temporarily creates a direct current path between power supplies VDD1 and VDD3 though the PFETs 132 and 160. This current path may cause a high cross-supply current (e.g., hundreds of milliamps) to flow from power supply VDD1 to power supply VDD3. This may also cause the voltage at power supply VDD3 to rise before it is powered up by the PMIC 110, as explained further below.

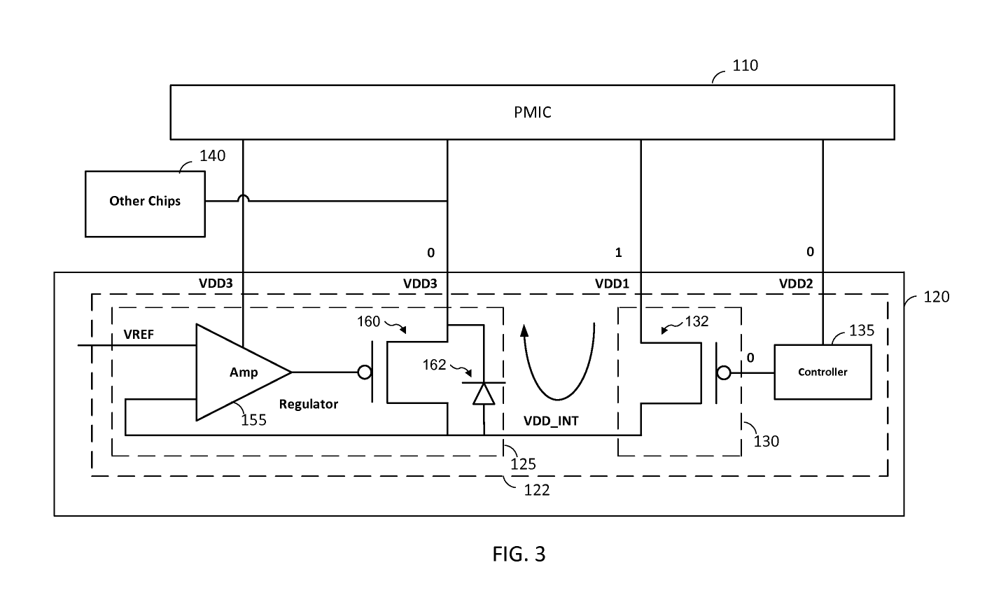

When power supply VDD1 is first powered up, power supply VDD3 is still at zero volts and the gate of the first PFET 132 is at zero volts or some undefined state since the controller 135 has not yet been reset. FIG. 3 shows an example of the voltages at power supplies VDD1 and VDD3 and the gate of the first PFET 132 immediately after power supply VDD1 is powered up, and before power supply VDD3 is powered up. At this time, power supply VDD1 is at its normal operating voltage (e.g., 1.0 V), power supplies VDD2 and VDD3 are at zero volts, and the gate of the first PEFT 132 is at zero volts.

Since the gate of the first PFET 132 is at zero volts, the first PFET 132 is turned on. As a result, the first PFET 132 creates a current path from power supply VDD1 to the internal power supply VDD_INT, and pulls up the voltage at the internal power supply VDD_INT to approximately the voltage at power supply VDD1. The voltage at the internal power supply VDD_INT forward biases the intrinsic diode 162 of the second PFET 160 since power supply VDD3 is still at zero volts. When the forward bias reaches the turn-on voltage of the diode 162, the diode 162 turns on and conducts current, thereby creating a current path from the internal power supply VDD_INT to VDD3. The voltage at the internal power supply VDD_INT may also turn on the second PFET 160, creating an additional current path from the internal power supply VDD_INT to power supply VDD3 through the second PFET 160. Thus, a direct current path is created between power supplies VDD1 and VDD3 though the PFETs 132 and 160, which can cause a high cross-supply current (e.g., hundreds of milliamps) to flow from power supply VDD1 to power supply VDD3 (represented by the curved arrow in FIG. 3).

The current through the diode 162 may also raise the voltage at power supply VDD3 before it is powered up by the PMIC 110. More particularly, the voltage at power supply VDD3 may be raised to a voltage approximately equal to the voltage at the internal power supply VDD_INT (which may be approximately equal to VDD1) minus the voltage drop across the diode 162. For example, when power supply VDD1 is powered up to 1.0V and the diode drop is approximately 0.5V, the voltage at power supply VDD3 may be raised to approximately 0.5V before it is powered up to its normal operating voltage (e.g., 1.8V) by the PMIC 110. This may upset other chips 140 that are coupled to VDD3 by raising the voltage at power supply VDD3 out of sequence. FIG. 4 shows an example of the rise in the voltage of power supply VDD3 caused by the current through the diode 162. As shown in this example, the voltage at power supply VDD3 rises to an intermediate voltage between zero volts and the normal operating voltage (e.g., 1.8) of power supply VDD3 before power supply VDD3 is powered up by the PMIC 110.

The current path between power supplies VDD1 and VDD3 shuts off when power supply VDD3 is powered up by the PMIC 110. This may be because VDD3 is greater than VDD1 when power supply VDD3 is powered up. More particularly, the current may shut off when VDD1 minus VDD3 becomes less than the turn-on voltage of the diode 162 and the absolute threshold value of the second PFET 160. Alternatively or in addition, the current path may shut off when VDD3 is powered up because logic in the voltage regulator 125 becomes active when VDD3 is powered up, and shuts off the second PFET 160 upon becoming active. Thus, the current path between power supplies VDD1 and VDD3 may exist between the time that power supply VDD1 is powered up and the time that VDD3 is powered up.

Embodiments of the present disclosure prevent cross-supply current by preventing a current path from forming between power supplies during power-up. For the example shown in FIG. 1, embodiments of the present disclosure prevent a current path from forming between power supplies VDD1 and VDD3 during power-up by shutting off the first PFET 132 until VDD1 minus VDD3 becomes less than the turn-on voltage of the diode 162 and the absolute threshold value of the second PFET 160. In one embodiment, the first PFET 132 is shut off until VDD3 exceeds VDD1.

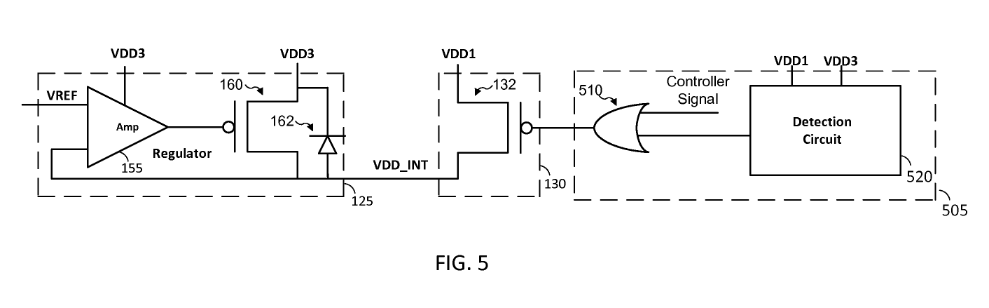

FIG. 5 shows a shut-off circuit 505 according to an embodiment of the present disclosure. The shut-off circuit 505 comprises an OR gate 510 and a detection circuit 520. A first input of the OR gate 510 is coupled to the controller 135 (not shown in FIG. 5) and a second input of the OR gate 510 is coupled to the detection circuit 520. The output of the OR gate 510 is coupled to the gate of the first PFET 132. Power supplies VDD1 and VDD3 are coupled to the detection circuit 520 so that the detection circuit 520 can detect the voltages of the power supplies VDD1 and VDD3, as explained further below.

During power-up, the detection circuit 520 detects power supply VDD1 powering up before power supply VDD3. The detection circuit 520 may do this by detecting when the voltage of power supply VDD1 reaches a threshold voltage while the voltage of power supply VDD3 is low (e.g., approximately zero volts). Upon detecting power supply VDD1 powering up before power supply VDD3, the detection circuit 520 outputs a logic one (e.g., 1.0V) to the OR gate 510. This causes the OR gate 510 to output a logic one to the gate of the first PFET 132 regardless of the logic state of the controller signal. The logic one shuts off the first PFET 132. Thus, the first PFET 132 is shut off regardless of the logic state of the controller signal. By shutting off the first PFET 132, the shut-off circuit 505 prevents formation of a current path from power supply VDD1 to the internal power supply VDD_INT through the first PFET 132, and therefore prevents formation of a current path between power supplies VDD1 and VDD3.

The detection circuit 520 also detects when power supply VDD3 is powering up. The detection circuit 520 may do this by detecting when the voltage of power supply VDD3 reaches a threshold voltage. In one example, the threshold voltage may be a voltage at which VDD1 minus VDD3 is less than the turn-on voltage of the diode 162. In another example, the threshold may be a voltage at which VDD1 minus VDD3 is less than the absolute threshold value of the second PFET 160. In yet another example, the threshold voltage may be a voltage approximately equal to or greater than VDD1. In this example, the detection circuit 520 may detect when power supply VDD3 is powering up by detecting when VDD3 is close to or exceeds VDD1.

Upon detecting power supply VDD3 powering up, the detection circuit 520 outputs a logic zero to the OR gate 510. The logic zero releases control of the first PFET 132 to the controller 135, allowing the controller 135 to control the first PFET 132 after reset is asserted. This is because, when a logic zero is input to the OR gate 510 by the detection circuit 520, the output of the OR gate 510 tracks the logic state of the controller signal. Also, when VDD3 powers up, logic in the regulator 125 may become active and shut off the current path through the second PFET 160.

Thus, the shut-off circuit 505 shuts off the first PFET 132 when it detects power supply VDD1 powering up before power supply VDD3 during the power-up sequence. The shut-off circuit 505 does not release control of the first PFET to the controller 135 until it detects power supply VDD3 powering up during the power-up sequence. In one embodiment, the shut-off circuit 505 releases control to the controller 135 when the voltage of power supply VDD3 exceeds the voltage of power supply VDD1. This ensures that the intrinsic diode 162 of the second PFET 162 is reversed biased, and therefore does not form a current path from the internal power supply VDD_INT to power supply VDD3 even if the first PFET 132 is turned on.

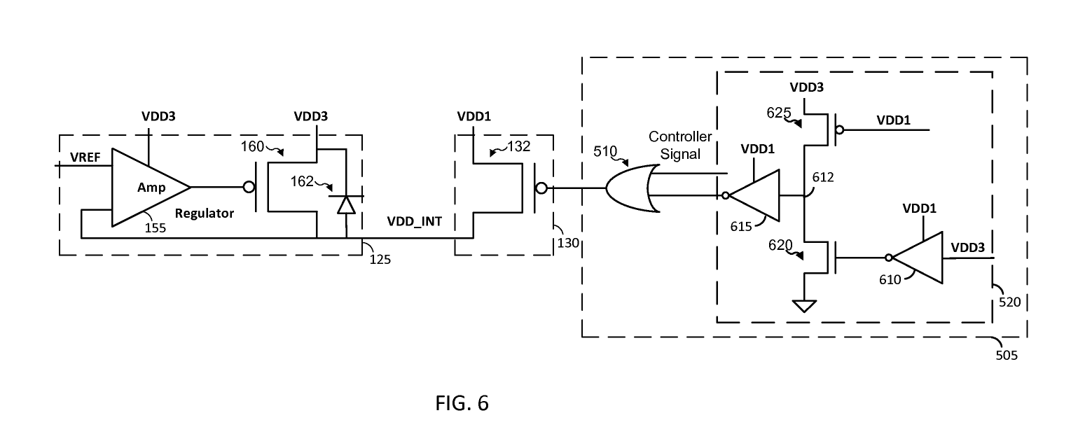

FIG. 6 shows an exemplary implementation of the detection circuit 520 according to an embodiment of the present disclosure. In this embodiment, the detection circuit 520 comprises a first inventor 610, a second inverter 615, a first n-type field effect transistor (NFET) 620 and a third PFET 625. The input of the first inverter 610 is coupled to power supply VDD3 and the output of the first inverter 610 is coupled to the gate of the first NFET 620. The gate of the third PFET 625 is coupled to power supply VDD1 and the source of the first PFET 625 is coupled to power supply VDD3. The input of the second inverter 615 is coupled to the drains of the first NFET 620 and the third PFET 625, and the output of the second inverter 615 is coupled to the second input of the OR gate 510. Both inverters 610 and 615 are powered by power supply VDD1. The inverters 610 and 615 may be implemented using Schmitt-trigger inverters or other type of inverter.

Operation of the detection circuit 520 during power-up will now be described. When power supply VDD1 is first powered up, power supply VDD3 is still at zero volts. As a result, the input of the first inverter 610 (which is coupled to VDD3) is low. This causes the first inverter 610 (which is powered by VDD1) to output a logic one to the gate of the first NFET 620. As a result, the first NFET 620 turns on and pulls the input (node 612) of the second inverter 615 to approximately ground. This causes the second inverter 615 (which is powered by VDD1) to output a logic one to the second input of the OR gate 510. As discussed above, this causes the OR gate 510 to output a logic one to the gate of the second PFET 132, and therefore shut off the second PFET 132, regardless of the logic state of the controller signal.

Thus, the detection circuit 520 in FIG. 6 detects when power supply VDD1 is powering up before power supply VDD3 by detecting when the voltage of power supply VDD1 becomes high enough to turn on the inverters 610 and 620 and the first NFET 620 while the voltage of power supply VDD3 is low (e.g., approximately zero volts).

When power supply VDD3 begins powering up, the voltage at the input of the first inverter 610 begins to rise. When VDD3 reaches a voltage that is high enough to flip the logic state of the first inverter 610, the output of the first inverter 610 (which is coupled to the gate of the first NFET 620) changes from logic one to logic zero. As a result, the first NFET 620 is turned off, and node 612 momentarily floats.

When VDD3 exceeds VDD1, the third PFET 625 begins to turn on. This is because the source-to-gate voltage of the third PFET 625 becomes positive when VDD3 exceeds VDD1. When the third PFET 625 turns on, the third PFET pulls up node 612 to a voltage approximately equal to VDD3. As a result, the input to the second inverter 615 becomes high, and the second inverter 615 outputs a logic zero to the second input of the OR gate 510. As discussed above, this releases control of the first PFET 132 to the controller 135. Thus, the shut-off circuit 505 shuts off the first PFET 132 until VDD3 exceeds VDD1, at which time, the shut-off circuit 505 releases control of the first PFET 132 to the controller 135.

Although the shut-off circuit 505 in the above example releases control of the first PFET 132 to the controller 135 when VDD3 exceeds VDD1, it is to be appreciated that the shut-off circuit 505 is not limited to this example and may be configured to release control of the first PFET 132 to the controller 135 at other voltages. For example, the shut-off circuit 505 may be configured to release control when VDD3 exceeds a threshold voltage. This may be done by coupling the gate of the third PFET 625 to the threshold voltage so that the third PFET 625 turns on and pulls the input (node 612) of the second inverter 615 high when VDD3 exceeds the threshold voltage. This threshold voltage is not to be confused with the threshold voltage of the third PFET 625. The threshold voltage may be chosen such that VDD1 minus VDD3 is less than the turn-on voltage of the diode 162 and/or less than the absolute threshold voltage of the second PFET 160 when VDD3 reaches the threshold voltage.

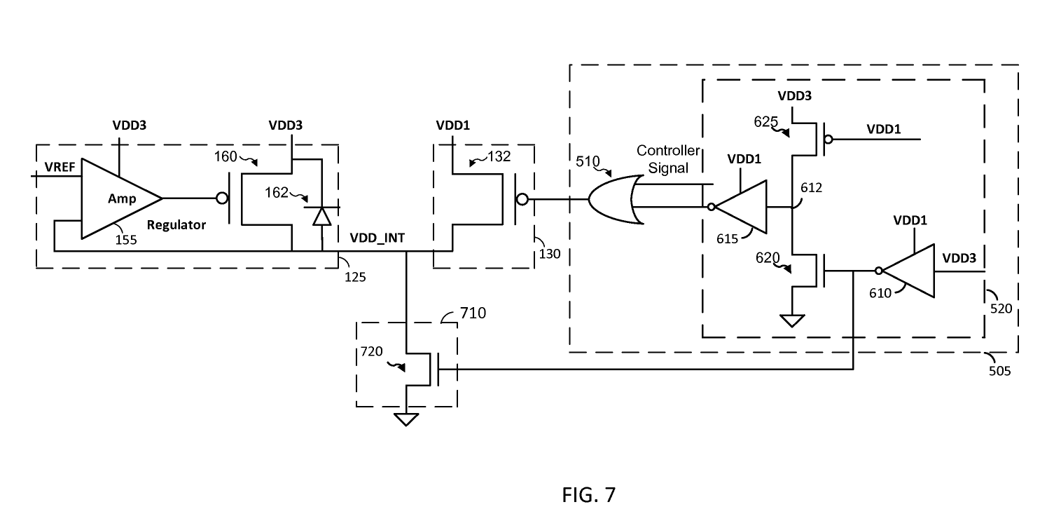

Even though the shut-off circuit 505 shuts off the first PFET 132 before VDD3 is powered up, leakage current on the order of hundreds of μA may pass through the first PFET 132. To address this, a current-shunt switch 710 may be coupled between the internal power supply VDD_INT and ground, as shown in FIG. 7. The shut-off circuit 505 may be configured to turn on the current-shunt switch 710 when VDD1 is powered up before power supply VDD3 to shunt leakage current from the internal power supply VDD_INT to ground before power supply VDD3 is powered up, and turn off the current-shunt switch 710 during normal operation.

In one embodiment, the current-shunt switch 710 comprises a second NFET 720 coupled between the internal power supply VDD_INT and ground. The gate of the second NFET 720 is coupled to the output of the first inverter 610 in the shut-off circuit 505. When power supply VDD1 is first powered up and power supply VDD3 is at zero volts, the first inverter 610 outputs a logic one to the gate of the second NFET 720. As a result, the second NFET 720 turns on and provides a current path for shunting leakage current from the first PFET 132 to ground. This keeps the internal power supply VDD_INT at approximately zero volts.

When power supply VDD3 begins powering up, the voltage at the input of the first inverter 610 begins to rise. When VDD3 reaches a voltage that is high enough to flip the logic state of the first inverter 610, the first inverter 610 outputs a logic zero to the gate of the second NFET 720, thereby turning off the second NFET 710. This may occur when VDD3 reaches a voltage that is slightly higher than half the voltage of VDD1. As a result, the second NFET 720 is turned off during normal operation, allowing the internal power supply VDD_INT to supply power to one or more circuits of the SoC 110 during normal operation.

The shut-off circuit 505 may be implemented in a small area of a chip compared with conventional power-up-reset circuits. This is because the shut-off circuit 505 is implemented using logic (e.g., inverters and switches), which occupy a much smaller chip area than resistors and capacitors used to provide time delays in conventional power-up-reset circuits. In addition, the shut-off circuit 505 is power efficient. This is because the shut-off circuit 505 is static during normal operation, and therefore consumes almost no DC power during normal operation.

Further, the shut-off circuit 505 does not need to be adjusted to adapt to changes in the timing of a power-up sequence. For example, the shut-off circuit 505 does not need to be adjusted if the time delay between power-up of power supply VDD1 and the power-up of power supply VDD3 changes. This is because the shut-off circuit 505 uses the detected voltages of power supplies VDD1 and VDD3 instead of a timing circuit to determine when to release control of the bypass switch 130 to the controller 135.

The shut-off circuit 505 may also be used to prevent cross-supply current during a power-down sequence. For example, during a power-down sequence, power supply VDD3 may be powered down before power supply VDD1, and the controller 135 may be shut down before power supply VDD1 is powered down. As a result, the power-down sequence may cause a cross-supply current to flow between power supplies VDD1 and VDD3 between the time that power supply VDD3 is powered down and the time that power supply VDD1 is powered down. In this example, when power supply VDD3 is powered down during the power-down sequence, the first invertor 610 flips logic states and outputs a logic one to the first NFET 620. This causes the first NFET to turn on and pull down the input (node 612) of the second inverter 615 to ground. This in turn causes the second inverter 615 to output a logic one to the second input of the OR gate 510. As discussed above, this shuts off the first PFET 132, and therefore prevents cross-supply current, regardless of the logic state of the controller signal. Thus, the shut-off circuit 505 detects power supply VDD3 powering down before power supply VDD1 during a power-down sequence, and shuts off the first PFET 132 upon detecting power supply VDD3 powering down before power supply VDD1.

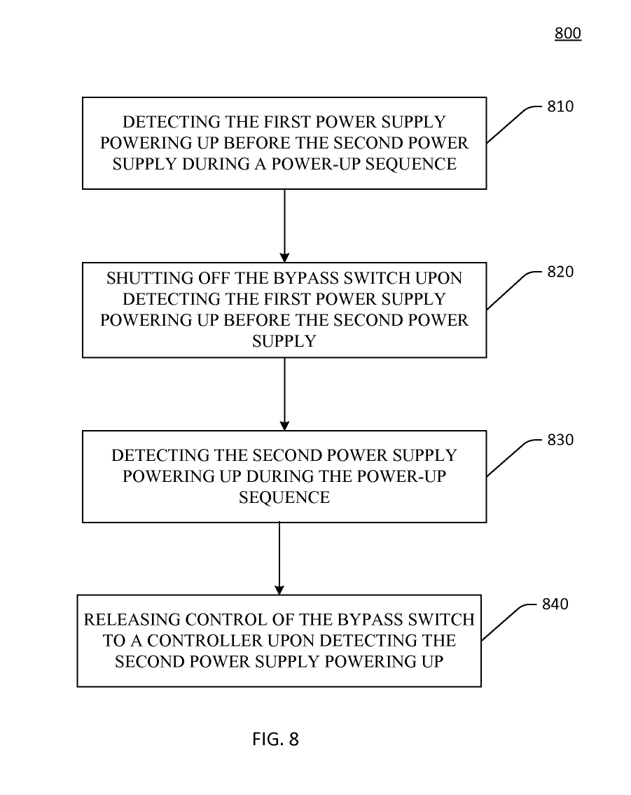

FIG. 8 illustrates a method 800 for preventing cross-supply current according to an embodiment of the present disclosure. The method 800 may be performed to prevent cross-supply current between a first power supply (e.g., VDD1) and a second power supply (e.g., VDD3) in a power circuit including a bypass switch (e.g., bypass switch 130) coupled between the first power supply and an internal power supply (e.g., VDD_INT), and a voltage regulator (e.g., voltage regulator 125) coupled between the second power supply and the internal power supply.

In step 810, the first power supply is detected powering up before the second power supply during a power-up sequence. This may be done, for example, by detecting the first power supply (e.g., VDD1) reaching a threshold voltage while the second power supply (e.g., VDD3) is low (e.g., approximately zero volts).

In step 820, the bypass switch is shut off upon detecting the first power supply powering up before the second power supply. For example, the bypass switch may be implemented using a PFET (e.g., the first PFET 132) that is shut off by driving the gate of the PFET high.

In step 830, the second power supply is detected powering up during the power-up sequence. This may be done by detecting when the voltage of the second power supply (e.g., VDD3) exceeds the voltage of the first power supply (e.g., VDD1). This may also be done by detecting when the voltage of the second power supply (e.g., VDD3) is equal to or greater than a threshold voltage. The threshold voltage may be chosen such that, when the second power supply (e.g., VDD3) reaches the threshold voltage, the voltage of the first power supply (e.g., VDD1) minus the voltage of the second power supply (e.g., VDD3) is less than the turn-on voltage of a diode (e.g., diode 162) in the voltage regulator (e.g., voltage regulator 125) and/or less than the absolute threshold voltage of a transistor (e.g., the second PFET 160) in the voltage regulator (e.g., voltage regulator 125).

In step 840, control of the bypass switch is released to a controller upon detecting the second power supply powering up. For example, control of the bypass switch (e.g., the first PFET 132) may be released to the controller (e.g., controller 135) using an OR gate (e.g., OR gate 510).

Those skilled in the art will appreciate that the circuits described herein may be realized using a variety of transistor types, and are therefore not limited to the particular transistor types shown in the figures. For example, transistor types such as bipolar junction transistors, junction field effect transistor or any other transistor type may be used. Those skilled in the art will also appreciate that the circuits described herein may be fabricated with various IC process technologies such as CMOS, bipolar junction transistor (BJT), bipolar-CMOS (BiCMOS), silicon germanium (SiGe), gallium arsenide (GaAs), etc.

The controller 135 may be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may perform the functions of the controller 135 described herein by executing software comprising code for performing the functions. The software may be stored on a computer-readable storage medium, such as a RAM, a ROM, an EEPROM, an optical disk, and/or a magnetic disk.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A power circuit, comprising:
a bypass switch coupled between a first power supply and an internal power supply;
a voltage regulator coupled between a second power supply and the internal power supply; and
a shut-off circuit configured to detect the first power supply powering up before the second power supply during a power-up sequence, to shut off the bypass switch upon detecting the first power supply powering up before the second power supply, to detect the second power supply powering up during the power-up sequence, and to release control of the bypass switch to a controller upon detecting the second power supply powering up.

2. The power circuit of claim 1, wherein the shut-off circuit is configured to detect the second power supply powering up by detecting a voltage of the second power supply exceeding a voltage of the first power supply.

3. The power circuit of claim 1, wherein the shut-off circuit is configured to detect the second power supply powering up by detecting when a voltage of the second power supply is equal to or greater than a threshold voltage.

4. The power circuit of claim 3, wherein the shut-off circuit is configured so that a voltage difference between the first power supply and the second power supply is less than a turn-on voltage of a diode in the voltage regulator when the voltage of the second power supply rises to reach the threshold voltage.

5. The power circuit of claim 3, wherein the shut-off circuit is configured so that a voltage difference between the first power supply and the second power supply is less than an absolute threshold voltage of a transistor in the voltage regulator when the voltage of the second power supply rises to reach the threshold voltage.

6. The power circuit of claim 1, further comprising a current-shunt switch coupled between the internal power supply and a ground, wherein the shut-off circuit is configured to turn on the current-shunt switch upon detecting the first power supply powering up before the second power supply, and to turn off the current-shunt switch upon detecting the second power supply powering up.

7. The power circuit of claim 1, wherein the bypass switch comprises a first p-type field effect transistor (PFET) and the shut-off circuit comprises:
a detection circuit; and
an OR gate having a first input coupled to the controller, a second input coupled to the detection circuit, and an output coupled to a gate of the first PFET;
wherein the detection circuit is configured to detect the first power supply powering up before the second power supply during the power-up sequence, to output a logic one to the second input of the OR gate upon detecting the first power supply powering up before the second power supply, to detect the second power supply powering up during the power-up sequence, and to output a logic zero to the second input of the OR gate upon detecting the second power supply powering up.

8. The power circuit of claim 7, wherein the detection circuit comprises:
a first inverter having an input coupled to the second power supply;
a first n-type field effect transistor (NEFT) having a gate coupled to an output of the first inverter;
a second inverter having an input coupled to a drain of the first NFET and an output coupled to the second input of the OR gate; and
a second PFET having a gate coupled to the first power supply, a source coupled to the second power supply, and a drain coupled to the input of the second inverter.

9. The power circuit of claim 8, further comprising a second NFET coupled between the internal power supply and a ground, and having a gate coupled to the output of the first inverter.

10. The power circuit of claim 1, wherein the shut-off circuit is configured to detect the second power supply powering down before the first power supply during a power-down sequence, and to shut off the bypass switch upon detecting the second power supply powering down before the first power supply.

11. A method for preventing cross-supply current between a first power supply and a second power supply in a power circuit including a bypass switch coupled between the first power supply and an internal power supply, and a voltage regulator coupled between the second power supply and the internal power supply, the method comprising:
detecting the first power supply powering up before the second power supply during a power-up sequence;
shutting off the bypass switch upon detecting the first power supply powering up before the second power supply;
detecting the second power supply powering up during the power-up sequence; and
releasing control of the bypass switch to a controller upon detecting the second power supply powering up.

12. The method of claim 11, wherein detecting the second power supply powering up comprises detecting a voltage of the second power supply exceeding a voltage of the first power supply.

13. The method of claim 11, wherein detecting the second power supply powering up comprises detecting when a voltage of the second power supply is equal to or greater than a threshold voltage.

14. The method of claim 13, wherein a voltage difference between the first power supply and the second power supply is less than a turn-on voltage of a diode in the voltage regulator when the voltage of the second power supply reaches the threshold voltage.

15. The method of claim 13, wherein a voltage difference between the first power supply and the second power supply is less than an absolute threshold voltage of a transistor in the voltage regulator when the voltage of the second power supply reaches the threshold voltage.

16. The method of claim 11, further comprising:
turning on a current-shunt switch coupled between the internal power supply and a ground upon detecting the first power supply powering up before the second power supply; and
turning off the current-shunt switch upon detecting the second power supply powering up.

17. The method of claim 11, further comprising:
detecting the second power supply powering down before the first power supply during a power-down sequence; and
shutting off the bypass switch upon detecting the second power supply powering down before the first power supply.

18. An apparatus for preventing cross-supply current between a first power supply and a second power supply in a power circuit including a bypass switch coupled between the first power supply and an internal power supply, and a voltage regulator coupled between the second power supply and the internal power supply, the apparatus comprising:
means for detecting the first power supply powering up before the second power supply during a power-up sequence;
means for shutting off the bypass switch upon detecting the first power supply powering up before the second power supply;
means for detecting the second power supply powering up during the power-up sequence; and
means for releasing control of the bypass switch to a controller upon detecting the second power supply powering up.

19. The apparatus of claim 18, wherein the means for detecting the second power supply powering up comprises means for detecting a voltage of the second power supply exceeding a voltage of the first power supply.

20. The apparatus of claim 18, wherein the means for detecting the second power supply powering up comprises means for detecting when a voltage of the second power supply is equal to or greater than a threshold voltage.

21. The apparatus of claim 20, wherein a voltage difference between the first power supply and the second power supply is less than a turn-on voltage of a diode in the voltage regulator when the voltage of the second power supply reaches the threshold voltage.

22. The apparatus of claim 20, wherein a voltage difference between the first power supply and the second power supply is less than an absolute threshold voltage of a transistor in the voltage regulator when the voltage of the second power supply reaches the threshold voltage.

23. The apparatus of claim 18, further comprising:
means for turning on a current-shunt switch coupled between the internal power supply and a ground upon detecting the first power supply powering up before the second power supply; and
means for turning off the current-shunt switch upon detecting the second power supply powering up.

24. The apparatus of claim 18, further comprising:
means for detecting the second power supply powering down before the first power supply during a power-down sequence; and
means for shutting off the bypass switch upon detecting the second power supply powering down before the first power supply.
